(19) United States
(12) Patent Application Publication
(10) Pub. No.: US 2012/0085091 A1
(43) Pub. Date: Apr. 12, 2012

(54) Supercharged Internal Combustion Engine

(76) Inventor: Jean Frederic Melchior, Paris (FR)

(21) Appl. No.: 13/259,029

(22) PCT Filed: Mar. 23, 2010
(86) PCT No.: PCT/FR2010/000247

§ 371 Date: Dec. 12, 2011

(30) Foreign Application Priority Data
Mar. 30, 2009 (FR) 09 01538

(51) Int. Cl. F02D 23/00

(52) U.S. Cl. 60/600

(57) ABSTRACT

Four-stroke internal combustion engine comprising N groups of two or three cylinders the exhaust phases of which do not interfere with one another, the exhaust ports (6) of which are linked together by an individual exhaust manifold (3) which communicates with a common inlet manifold (2) and is linked to one of the N inlets (19) of a shutter (14) the single outlet of which is connected to the inlet of a turbine (5), common to the N groups and which is controlled in such a way as to open an exclusive communication between the turbine (5) and each exhaust manifold (3) at least for the duration of the puffs of exhaust gases emitted by one of the cylinders that it is emptying.

The invention relates to four-stroke reciprocating internal combustion engines, in particular those that are turbocharged, of which the combustions are equally-distant in time and which comprise several groups of two or three cylinders of which the exhaust phases do not interfere with one another, such as the V12 and the V8 which have four groups of cylinders or the six and four cylinders in a V-configuration or in line which have two groups of cylinders.

The invention applies more particularly to engines with a high rate of burnt gas recirculation in order to reduce nitrogen oxide emissions by implementing the method of FR 2 909 7188A 1 which discloses an application with a group of four cylinders. This method consists substantially in separating the mass of hot gases emitted at each cycle by a cylinder into a first highly energetic puff resulting from the pressure drop at the time of the opening of the exhaust ports which will be expanded in a turbine and a second less energetic residual mass which will be discharged by the piston during its exhaust stroke into a bypass pipe communicating with the intake manifold and/or with the outlet of said turbine. It occurs that the puff expanded down to the intake pressure in the neighborhood of the bottom dead centre of the piston represents between 50% and 60% of the total mass emitted by the cylinder and that the remaining 50% to 40% fraction falls close to the recirculation rate required to remove the nitrogen oxides. This coincidence makes it possible to conclude that a selective use of the puff and of the mass of gas remaining in the cylinder provides simultaneously a maximum power to the turbine, a total removal of the nitrogen oxides and a pumping work of the pistons in the neighborhood of zero.

In the alternative where the bypass pipe does not communicate with the inlet manifold, the pressure in the bypass pipe can be much below the intake pressure and approach atmospheric pressure when it communicates with the outlet of the turbine. In this case, the second mass of hot gases discharged by the pistons represents only a low fraction of the total mass emitted at each cycle which will be almost entirely expanded in the turbine. This alternative makes it possible to improve the output of a four-stroke engine by generating a positive work during the intake-exhaust transfer cycle.

This invention has in particular for object to extend the application of this method to engines comprising several groups of cylinders supplying the same turbine through an undivided nozzle, and to optimize its impact on the reduction of the consumption of fuel and of polluting emissions.

It is already known to expand the puffs emitted by the exhaust manifold of a group of two or three cylinders in a turbine assigned to this group or in a turbine that is common to several groups, turbine of which the nozzle is divided. This method however loses its effectiveness when a port is opened permanently in the exhaust manifold in order to divert a fraction of the burnt gases towards the intake manifold or towards the outlet of a turbine. Indeed, this additional outlet swallows a portion of the puff which is not expanded in the turbine. The aforementioned document solves this problem by periodically closing the bypass port during the blow down period and by guaranteeing as well as that the entire puff is expanded in the turbine. The effectiveness of the concept increasing with the number of cylinders which supply the same turbine, it is advantageous to link all of the manifolds of the engine to a single turbine through a nozzle which is not divided. To do this, the confluence of the manifolds must be organized at the inlet of the turbine without creating communications which would allow the puffs or one of them to rise into another.

As a first approximation, the time needed for the expansion of a puff of exhaust gases is inversely proportional to the discharge area of the turbine. As such, for a fixed area turbine, the angular duration of the puff is proportional to the speed of rotation of the engine. Yet, the angular duration of the puff must not exceed 60 crank angle degrees surrounding the bottom dead centre of the piston in order to minimize the negative work of the exhaust stroke of the piston. An increase in the section of the turbine is therefore required in order to balance the effect of an increase in speed. The application of the invention to variable speed engines (road traction) will therefore be articulated, more preferably, around a variable area turbine of which the nozzle comprises pivoting vanes arranged around the rotor.

Moreover, as the duration of the puff is set to 60 crank angle degrees, the angular period separating two consecutive puffs, a period when the turbine is supplied with less energetic gases, is inversely proportional to the number of cylinders which supply the turbine. This period is respectively: 180 degrees for three cylinders; 120 degrees for four cylinders; 60 degrees for six cylinders: 40 degrees for eight cylinders; 0 degrees for twelve cylinders. These figures show the interest of increasing the number of cylinders supplying the same turbine in order to minimize the fraction of the low energetic gases that supply it. A single turbine will therefore receive the puffs of all of the cylinders of the engine.

As such the turbine of eight- or twelve-cylinder engines mostly expands highly energetic puffs. For smaller numbers of cylinders, either the turbine is partially supplied with less energetic gases, or the angular duration of the puffs is extended at the price of a larger pumping work of the pistons during exhaust strokes.

With the preceding constraints, the problem to be resolved is to supply a single turbine from several (in practice two or four) exhaust manifolds each linked to a group of two or three cylinders of which the exhaust phases do not interfere with one another, in such a way as to prevent a puff growing in one of the manifolds from flowing into another manifold.

In addition, the means to be provided must also make it possible to put into communication each cylinder with the bypass pipe during the discharge stroke of the piston, in accordance with the aforementioned document.

The invention proposes to this effect a reciprocating internal combustion engine operating on the four-stroke cycle with equally-distant combustions in time and comprising N groups of two or three cylinders of which the exhaust phases do not interfere with one another, cylinders of which the inlet ports are linked to an intake manifold that is common to the N groups and of which the exhaust ports are linked together by an individual exhaust manifold which communicates with a bypass pipe in such a way that the communication is cut off before the opening of the exhaust valves of each cylinder of the group and is re-established before the closing of said valves, characterized in that each individual exhaust manifold is linked to one of the N inlets of an N-channel distributing valve of which the single outlet is linked to the inlet of a turbine that is common to the N groups, valve controlled in such a way as to open an exclusive communication between the turbine and each individual exhaust manifold, at least during the duration of the puffs of exhaust gases emitted by one of the cylinders that it is emptying.

According to the invention, the gas inlet of the single turbine is therefore provided with a valve comprising several inlets ports (in practice two or four) each linked to an individual exhaust manifold and a single outlet linked to the gas inlet of the turbine. The valve is controlled in such a way as to periodically put the turbine in exclusive communication with each individual exhaust manifold at least during the puff of exhaust gases of one of the cylinders that it is emptying. The angular duration of the exclusive periods, which is common to all of the individual manifolds, therefore depends on the duration of the puff, ideally less than 60 degrees of rotation of the crankshaft. Outside of this exclusive period, the turbine may communicate with two manifolds which are not emitting puffs and wherein the pressure is that of the bypass conduit.

Optionally, the same valve can provide the periodical putting into communication of each individual exhaust manifold with the bypass pipe.

According to other characteristics of the invention:
the turbine is put into periodic communication with each exhaust manifold during the angular periods of rotation of the crankshaft that are identical and equally-distant, at least equal to 720 degrees divided by the number of cylinders of the engine, periods encompassing the duration of the puffs emitted by one of the cylinders that it is emptying,
the turbine is put into communication with two exhaust manifolds at the beginning and at the end of each angular period, before and after the duration of the puffs emitted by one of the cylinders that they are emptying, during the simultaneous opening and closing of the two inlets of the distributing valve to which they are linked.

In practice, the most common engines comprise an even number of cylinders divided into two or four groups of two or three cylinders. For the remainder of the description, this will therefore be limited to N=2 (four and 6 cylinders) and N=4 (eight and twelve cylinders).

In the case of an engine comprising two or four groups of two or three cylinders:
the distributing valve comprises a fixed cylindrical chamber, open axially towards the turbine, and of which the cylindrical wall comprises two or four identical rectangular inlet ports equally angularly distributed, in front of a coaxial rotating shutter rotating at the speed of the drive shaft for engines comprising groups of two cylinders and at 1.5 times this speed for engines comprising groups of three cylinders,
the rotating shutter comprises a circular disk adjusted to the cylindrical wall of the chamber and perpendicular to the axis of rotation, which carries a coaxial cylindrical sector adjusted to the said cylindrical wall of the chamber and which is developed axially towards the turbine above the inlet ports,
the engine comprises two groups of cylinders, the distributing valve comprises two inlet ports arranged at 180 degrees and the cylindrical sector of the shutter is developed over an angle of 180 degrees,
the engine comprises four groups of cylinders, the distributing valve comprises four inlet ports arranged at 90 degrees and the cylindrical sector of the shutter is developed over an angle of 270 degrees,
the disk is located axially below the inlet ports and the cylindrical sector covers the entire height of the inlet ports,
the disk is located substantially at mid-height of the inlet ports, the cylindrical sector only closes the upper portion of the inlet ports communicating with the turbine and it carries on its lower face a second cylindrical sector adjusted to the surface which closes the lower portion of the inlet ports communicating with a bypass pipe via an outlet port exiting into the lower portion of the cylindrical chamber,
the sector is wedged in order to close the communication between the bypass pipe and an individual exhaust manifold during the duration of the puff emitted by one of the cylinders that it is emptying,
the discharge area of the turbine is chosen so that the angular duration of the puff is in the neighborhood of 60 crank angle degrees.
the speed of the engine is variable and the section of the turbine increases with the speed of the engine in order to adjust the angular duration of the puff,
the bypass pipe communicates with the inlet manifold,
the bypass pipe is isolated from the inlet manifold (2) and communicates with the outlet of the turbine,
the turbine drives the supercharging compressor of the engine,
the shaft of the turbine is linked to the crankshaft of the engine or to an auxiliary power take-off.

The invention shall be better understood and other characteristics, details and advantages of the latter will appear more clearly when reading the following description, provided by way of example in reference to the annexed drawings wherein:

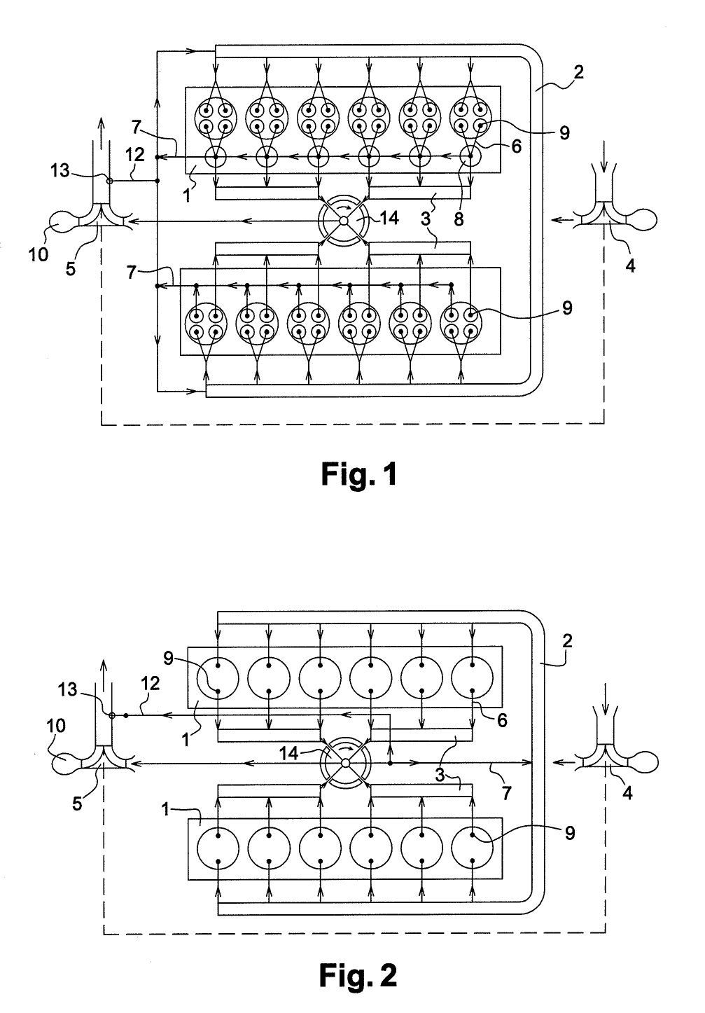

FIG. 1 is a diagrammatical view of a first embodiment of the invention applied to a twelve-cylinder turbocharged engine in a V-configuration wherein the exhaust-inlet communication is arranged in the cylinder heads;

FIG. 2 is a diagrammatical view of a second embodiment of the invention applied to a twelve-cylinder turbocharged engine in a V-configuration with unmodified cylinder heads wherein the inlet-exhaust communication is established via the four-channel distributing valve;

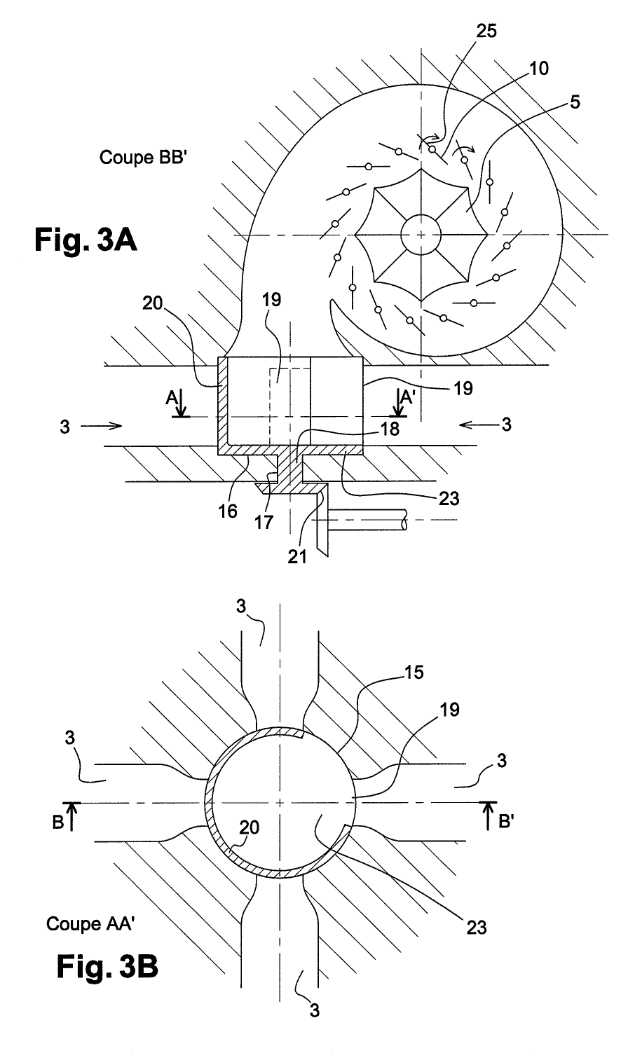

FIGS. 3A and 3B show an axial cross-section and a transversal cross-section of the distributing valve 14 supplying the turbine of FIG. 1;

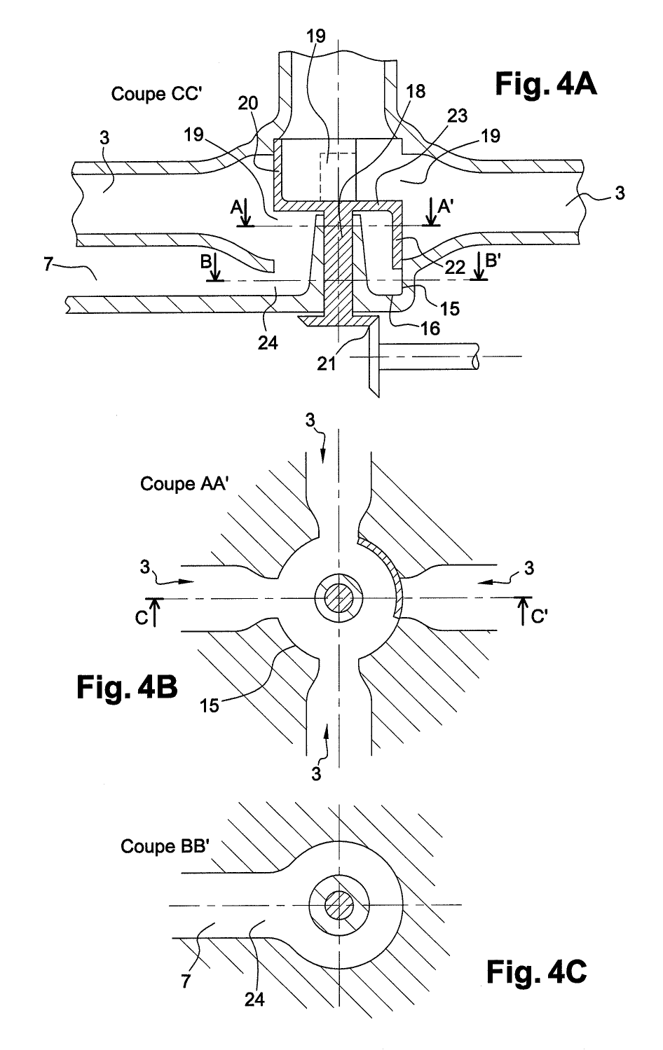

FIGS. 4A, 4B and 4C show an axial cross-section and two transversal cross-sections of a distributing valve supplying the turbine and managing the communication between the exhaust and inlet circuits of FIG. 2;

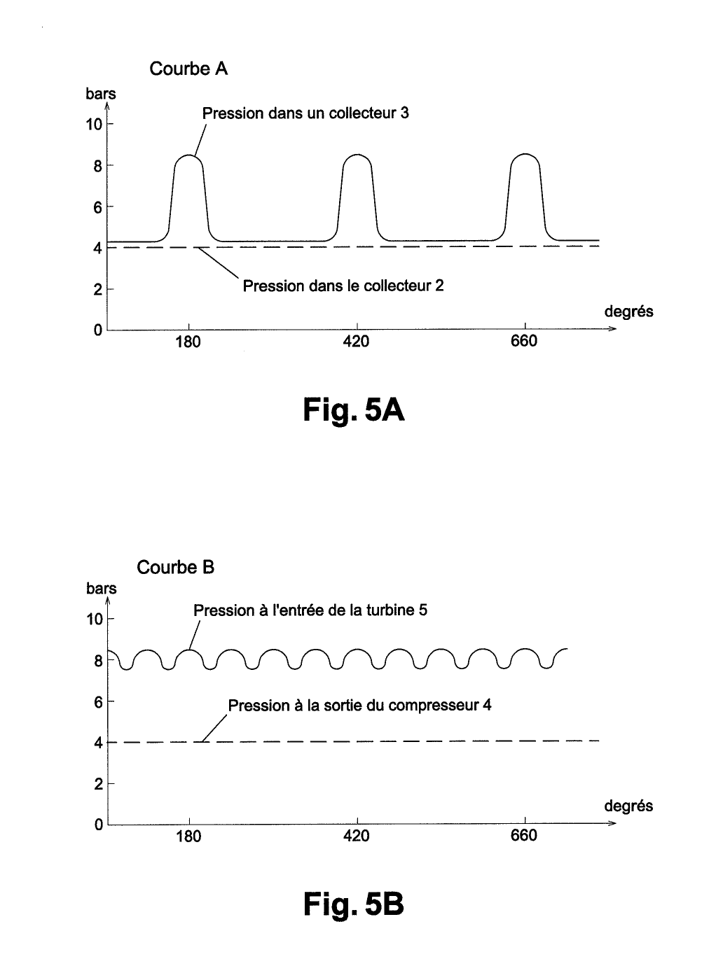

FIGS. 5A and 5B show the instantaneous pressures in the inlet and exhaust manifolds of the 12-cylinder engine of FIG. 2 as well as at the inlet of the turbine and at the outlet of the compressor;

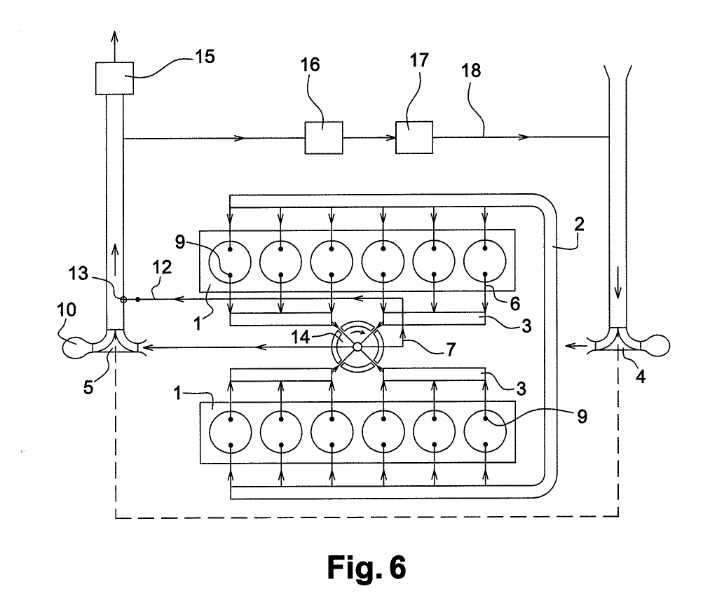

FIG. 6 is an alternative of FIG. 2 wherein the bypass pipe is isolated from the inlet manifold;

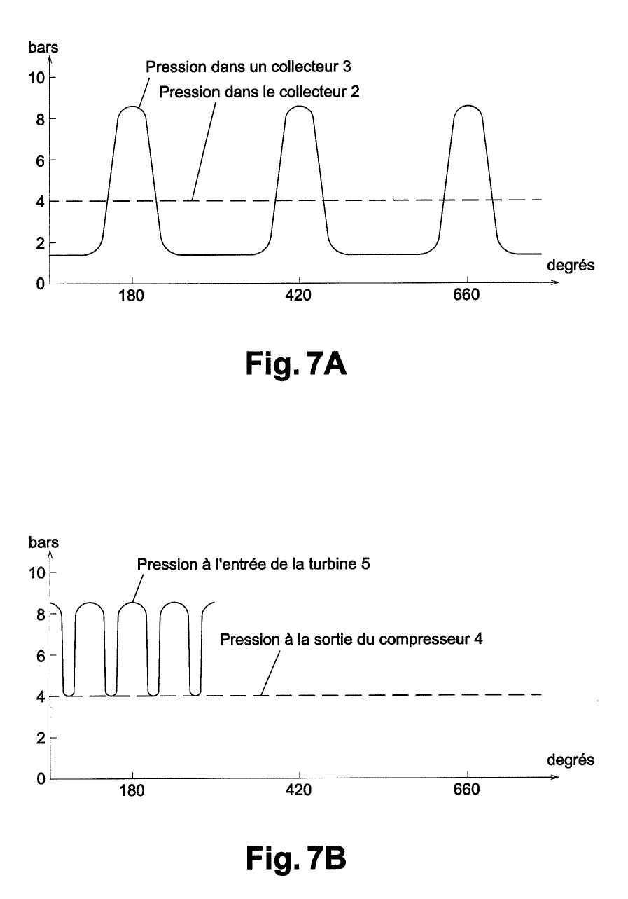

FIGS. 7A and 7B are alternatives of FIGS. 5A and 5B corresponding to the configuration of FIG. 6.

Generally, FIGS. 1 to 5 relate to an embodiment with a bypass pipe communicating with the inlet manifold and FIGS. 6 and 7 an embodiment with a bypass pipe isolated from the inlet manifold.

Reference will first be made to FIGS. 1 and 3 wherein the reference 1 designates a four-stroke twelve-cylinder reciprocating engine in a V-configuration open at 60 degrees distributed into four groups of three cylinders successively igniting every 60 degrees of rotation of the drive shaft. The engine 1 comprises an intake manifold 2 common to the 12 cylinders and four exhaust manifolds 3 of minimal volume linked respectively to the exhaust ports 6 of each group of 3 cylinders.

The intake manifold 2 is supplied with air by a compressor 4 driven by a turbine 5 of which the nozzle 10 with variable geometry is comprised of a ring of pivoting vanes.

Two examples of routing of the recirculated burnt gases are shown in FIG. 1.

On the cylinder bank at the top of the figure, a bypass pipe 7 common to the six cylinders links the exhaust ports 6 via isolation valves 8 to the inlet manifold 2. The isolation valves 8 of each group of cylinders close the communication between its manifold 3 and the bypass pipe 7 before the opening of the exhaust valves 9 of each cylinder of the group and open said communication before the closing of said valves 9. The positioning of the isolation valves 8 as close as possible to the exhaust valves 9 makes it possible to reduce to a minimum the volume of the manifolds 3 without creating resistance to the flow of the returned gases which do not pass through these manifolds. The valves 8 of each group of cylinders can be actuated simultaneously by a specific camshaft driven in synchronism by the crankshaft at 1.5 times the engine speed or be actuated successively by additional cams carried by the exhaust camshaft of the engine.

The other cylinder bank shows another routing of the returned gases which can be considered on the engines with a very high cylinder bore to piston stroke ratio and low piston speed of which each cylinder comprises two large exhaust valves discharging towards two separate cylinder head exhaust ports linked respectively to a manifold 3 and to the pipe 7. The valve linked to the manifold 3 opens before the bottom dead centre of the piston in order to discharge the pressure of the cylinder towards the turbine. The valve linked to the conduit 7 provides the function of the isolation valve 8 by opening after the puff in order to return the residual gases towards the inlet manifold 2. The communication between the manifolds 3 and the inlet manifold 2 then passes through the interior of the cylinders: This very simple solution has the disadvantage of increasing the pumping work of the piston and of reducing the effectiveness of the pressure pulses.

Optionally, a bypass conduit 12 provided with a regulating valve 13 of the flow which passes through it links the bypass pipe 7 to the outlet of the turbine 5. The valve 13 makes it possible to refine the recirculation rate of the burnt gases and the excess air for the combustion and to limit the inlet pressure at high speeds.

The exhaust ports 6 of the four groups of three cylinders are linked to four individual manifolds 3 located inside the V. Each exhaust manifold 3 is linked to one of the four inlets ports 19 of a rotating distributing valve 14. The configuration of the cranks of the crankshaft and the ignition order of the cylinders are chosen so that the manifolds 3 successively emit a puff in the order of the opening of the ports to which they are linked.

The valve 14 comprises a fixed casing with a vertical axis forming a cylindrical cavity closed downwards by a bottom 16, which carries the bearing 17 of the rotor 18 and the pair 21 of bevel gears driven by the crankshaft, and opens upwards on the gas inlet of the turbine 5. The interior cylindrical surface 15 of the casing comprises four rectangular ports 19 with areas substantially equal to the section of the manifolds 3 and arranged angularly every 90 degrees. For the remainder of the description, the angular development of each port 19 is arbitrarily set to 20 degrees. Each of the ports 19 is linked to a manifold 3 according to the ignition order.

The rotor 18, which rotates at 1.5 times the engine speed, comprises a cylindrical shutter 20 coaxial to the inside surface 15 of the casing and adjusted on the latter with a minimal clearance. The shutter 20 of the rotor is open on a sector of 90 degrees in such a way as to close three ports 19 when the fourth is fully open and to maintain the same area supplying the turbine during the transition from one port to the next one. In these conditions, the turbine is supplied by a single manifold 3 over 70 degrees of rotor, which is 47 degrees of crankshaft rotation and supplied by two manifolds 3 during 20 degrees of rotor, which is 13 degrees of crankshaft rotation.

It is clear that the rotor is wedged so that its opening coincides with the axes of two adjacent ports at the time when the pressures in the corresponding manifolds cross. The area of the nozzle of the turbine can be adjusted, in a known manner, by the simultaneous pivoting of the vanes 25 on their axis in order to adjust the angular duration of the puffs according to the recirculation rate/excess air compromise required by the combustion. The turbine is as such supplied with successive puffs in the order that they are emitted by the twelve cylinders of the engine. The rotating valve hereinabove can be used on an eight-cylinder engine when it is made to rotate at the engine speed.

For four and six cylinders, the wall 15 would contain only two ports 19 arranged at 180 degrees and the shutter 20 would be open over 180 degrees, the rotor rotating at the engine speed for four cylinders and at 1.5 times the engine speed for six cylinders.

Reference will now be made to FIGS. 2 and 4.

It is also possible to make use of the invention without modifying the cylinder head of the engines by using an alternative of the rotating valve 14 which, in addition to their communication with the turbine, also manages the communication between the exhaust manifolds 3 and the inlet manifold 2.

The alternative of the valve 14 shown in FIG. 4 carries the same references and is shown in the same position as that of FIG. 3. It is associated with a V12 engine devoid of isolation valves 8 shown in FIG. 2. The two return conduits 7 are here replaced with a single bypass conduit 7 linking a second outlet 24 of the distributing valve 14 to the intake manifold 2.

This alternative is distinguished from the previous valve by the fact that the cylindrical wall 15 of the fixed casing comprises a second outlet 24 located axially between the ports 19 and the bottom 16. In addition, the disk 23 of the rotor 18 is located axially substantially at mid-height of the inlet ports 19 and carries a second cylindrical shutter 22 on its lower face. This cylindrical sector 22 is developed over 90 degrees and its axial height stops at the upper edge of the outlet port 24. The sector 22 extends the opening of the sector 20 in such a way that, simultaneously, the rotor 18 opens the communication between a manifold 3 and the turbine and closes the communication between this manifold 3 and the bypass conduit 7 and vice versa.

As previously, this alternative can be adapted to four-, six- and eight-cylinder engines with the modifications already described. In addition, the angular development and the wedging of the shutter 22 must be adapted so that it closes a half-port 19 during the duration of the puff. This angular development will therefore be limited to 90 degrees for four and eight cylinders and to 120 degrees for six and twelve cylinders.

Reference will now be made to FIG. 5 which shows the instantaneous pressures according to the position of the crankshaft of a twelve cylinder engine: A in the inlet manifold 2 as a dotted line and in an exhaust manifold 3 as a dashed line; B at the outlet of the compressor 4 as a dotted line and at the inlet of the turbine 5 as a dashed line. It can be seen on these curves that the turbine 5 supplied by gases of which the average pressure can reach twice the pressure delivered by the compressor 4, develops much more power than required by the compression of the intake air. It is generally advantageous to associate the invention with two turbocompressors operating in series, the turbocompressor described previously comprising the high-pressure compressor. The refrigeration of the air between the compressors reduces the work of compression and amplifies the additional power developed by the turbines. This additional power can be returned to the crankshaft by a “turbo-compound” system in order to increase the power and the thermal efficiency of the engine. For large engines provided with high isentropic efficiency turbochargers, the gain in power and in thermal efficiency can exceed 10%. An advantageous configuration then consists in linking the turbine 5 to the crankshaft via the shaft which drives the rotating valve 14 and in locating the turbine of the turbocharger downstream of the turbine 5. The adjusting of the variable nozzle 10 then makes it possible to control the sharing of the exhaust gases enthalpy between the compression of the air and the power recovered on the crank shaft.

Reference will now be made to FIG. 6 which shows the engine of FIG. 2 of which the communication between the bypass conduit 7 and the inlet manifold 2 has been cut off. The totality of the bypassed flow then passes through the conduit 12 towards the outlet of the turbine 5. The conduit 12 is more preferably largely dimensioned so that the pressure therein is substantially constant despite the fluctuations of the flow which supplies it. When the valve 13 is fully open, this pressure is that of the outlet of the turbine 5.

In the cases where burnt gases must be recirculated in order to limit NOx emissions, a return conduit 18 links the outlet of the turbine 5 to the inlet of the compressor 4 via a particulate filter 16 and a cooler 17. The non-returned gases are discharged into the atmosphere via a post-treatment device 15. In an alternative, the return conduit 18 can tap its gases downstream of the device 15 and join the inlet of the compressor via a simple refrigerant 17. The pressure in the bypass conduit 7 is then the atmospheric pressure increased by the pressure loss created by the device 15 which must be reduced to the minimum.

The turbine 5 can comprises two turbine stages and the compressor 4 can comprise two compression stages. In this case, it can be advantageous to provide a conduit linking the conduit 12 to the inter-turbine space via a throttling valve 13.

Reference will now be made to FIGS. 7 A and 7B.

FIG. 7 A shows the instantaneous pressure in each manifold 3 when the valve 13 is fully open. It can be seen that the discharge pressure of the burnt gases is in the neighborhood of the atmospheric pressure while the inlet pressure is 4 bars. During the gas exchange phases, the engine develops an average indicated pressure of 3 bars which is added to the work provided by the closed cycle of the engine.

FIG. 7B shows the instantaneous pressure at the inlet of the turbine 5 of which the average value is clearly higher than the intake pressure.

When the totality of the power of the turbine 5 (single-stage or two-stage) is absorbed by the compressor 4 (single-stage or two-stage) that it is driving, the pressure in the inlet manifold 2 can exceed the threshold compatible with the mechanical resistance of the engine when the latter is operating at high load. It is advantageous in this case to prematurely close the inlet valves in order to partially expand the intake air at the end of the intake stroke (Miller cycle).

The additional power can also be tapped on the shaft of the turbine 5 as described above.

Key to the figures
FIG. 3A

| | |
|---|---|
| Coupe BB′ | Section BB′ |

FIG. 3B

| | |
|---|---|
| Coupe AA′ | Section AA′ |

FIG. 4A

| | |
|---|---|
| Coupe CC′ | Section CC′ |

FIG. 4B

| | |
|---|---|
| Coupe AA′ | Section AA′ |

FIG. 4C

| | |
|---|---|
| Coupe BB′ | Section BB′ |

FIG. 5A

| | |
|---|---|
| Courbe A | Curve A |
| bars | bars |
| Pression dans un collecteur 3 | Pressure in a manifold 3 |
| Pression dans le collecteur 2 | Pressure in the manifold 2 |
| degrés | degrees |

FIG. 5B

| | |
|---|---|
| Courbe B | Curve B |
| bars | bars |
| Pression à l′entree de la | Pressure at the inlet of the |
| turbine | turbine |
| Pressions à la sortie du | Pressure at the outlet of the |
| compresseur 4 | compressor 4 |
| degrés | degrees |

FIG. 7A

| | |
|---|---|
| bars | bars |
| Pression dans un collecteur 3 | Pressure in a manifold 3 |
| Pression dans le collecteur 2 | Pressure in the manifold 2 |
| degrés | degrees |

FIG. 7B

| | |
|---|---|
| bars | bars |
| Pression à l′entree de la | Pressure at the inlet of the |
| turbine 5 | turbine 5 |
| Pression à la sortie du | Pressure at the outlet of the |
| compresseur 4 | compressor 4 |
| degr\acute{es} | degrees |

1. Reciprocating internal combustion engine operating on a four-stroke cycle with combustions equally-spaced in time and comprising N groups of two or three cylinders of which the exhaust phases do not interfere with one another, cylinders of which the inlet ports are linked to an intake manifold that is common to the N groups and of which the exhaust ports of the same group are linked together by an individual exhaust manifold which communicates with a bypass pipe in such a way that the communication is cut off before the opening of the exhaust valves of each cylinder of the group and is re-established before the closing of said exhaust valves, wherein each exhaust manifold is linked to one of the N inlets ports of a distributing valve of which the single outlet is linked to the inlet of a turbine that is common to the N groups, this valve being controlled in such a way as to open an exclusive communication between the turbine and each exhaust manifold at least during the duration of the puffs of exhaust gases emitted by one of the cylinders that it is emptying.

2. Engine according to claim 1, wherein the turbine is placed into periodic communication with each exhaust manifold during angular periods of rotation of the crankshaft that are identical and equally-spaced in time, at least equal to 720 degrees divided by the number of cylinders of the engine, periods encompassing the duration of the puffs emitted by one of the cylinders that it is emptying.

3. Engine according to claim 2, wherein the turbine is placed into communication with two exhaust manifolds at the beginning and at the end of each angular period, before and after the duration of the puffs emitted by one of the cylinders that they are emptying, during the simultaneous opening and closing of the two inlet ports of the distributing valve to which they are linked.

4. Engine according to claim 1, wherein the valve comprises a fixed cylindrical chamber, open axially towards the turbine, and of which the cylindrical wall comprises N identical rectangular inlet ports equally spaced angularly, in front of a coaxial rotating shutter rotating at the engine speed for groups of two cylinders and at 1.5 times this speed for groups of three cylinders.

5. Engine according to claim 4 of which the rotating shutter comprises a circular disk adjusted to the wall and perpendicular to the axis of rotation, wherein the disk carries a cylindrical sector coaxial and adjusted to the surface and which is developed axially towards the turbine above the inlet ports.

6. Engine according to claim 5, comprising two groups of cylinders, wherein the distributing valve comprises two inlet ports arranged at 180 degrees and in that the cylindrical sector is developed over an angle of 180 degrees.

7. Engine according to claim 4, comprising four groups of cylinders and wherein the distributing valve comprises four intake ports arranged at 90 degrees and in that the cylindrical sector is developed over an angle of 270 degrees.

8. Engine according to claim 4, wherein the disk is located axially below the ports and in that the cylindrical sector covers the entire height of the ports.

9. Engine according to claim 4 and of which the disk is located substantially at mid-height of the intake ports, wherein the sector closes only the upper portion of the ports communicating with the turbine and in that it carries on its lower face a second cylindrical sector adjusted to the surface which closes the lower portion of the ports communicating with a bypass conduit via an outlet port exiting into the lower portion of the cylindrical chamber.

10. Engine according to claim 9, wherein the sector is wedged in order to close the communication between the bypass conduit and an exhaust manifold during the duration of the puff emitted by one of the cylinders that it is emptying.

11. Engine according to claim 1, wherein the flow area of the turbine is chosen so that the angular duration of the puff is in the neighborhood of 60 degrees.

12. Engine according to claim 11, wherein the speed of the engine is variable and that the area of the nozzle of the turbine increases with the speed of the engine in order to adjust the angular duration of the puff.

13. Engine according to claim 1, wherein the bypass conduit communicates with the inlet manifold.

14. Engine according to claim 1, wherein the bypass conduit is isolated from the inlet manifold and communicates with the outlet of the turbine.

15. Engine according to claim 1, wherein the turbine drives the supercharging compressor of the engine.

16. Engine according to claim 15, wherein the shaft of the turbine is linked to the crankshaft of the engine or to an auxiliary power take-off.
